(19) United States
(12) Patent Application Publication
(10) Pub. No.: US 2012/0180350 A1
(43) Pub. Date: Jul. 19, 2012

(54) Sign stake

(76) Inventor: Mark J. Daus, St. Louis, MO (US)

(21) Appl. No.: 13/374,775

(22) Filed: Jan. 12, 2012

Related U.S. Application Data
(60) Provisional application No. 61/461,182, filed on Jan. 14, 2011.

(51) Int. Cl. G09F 15/00

(52) U.S. Cl. 40/607.06

(57) ABSTRACT

A stake for holding a sign upright and comprising two parallel and spaced apart elongated legs, formed of a lower structure, with one end of each leg being driving into the ground, and with the upper side rails of the structure provided for supporting a sign in place, above the ground. A laterally applied cross rail secured by welding or otherwise to the upright side rails. The lower structure is formed of two side pieces, integrally bent to also form a cross member, and having the side rails welded thereto, for forming the entire sign stake. The lower structure is formed of square or rectangular metal stake and forms a flattened step to facilitate application of the stake into the ground.

### CROSS REFERENCE TO RELATED APPLICATION

This non provisional patent application claims priority to provisional patent application having Ser. No. 61/461,182, filed on Jan. 14, 2011, which also claims priority to the design patent No. D651,654, filed Mar. 3, 2011.

### FIELD OF THE INVENTION

This invention relates to support for signage, and more specifically pertains to a structural steel or other materials support for holding signage, and which is reinforced to substantially lessen any breakage during application of the sign during usage, and simultaneously, has structural relationship that makes it more convenient for forcing the lower portion of the sign into the ground, during its installation.

### BACKGROUND OF THE INVENTION

As stated, this invention relates to a wire sign stake used for supporting the corrugated type of sign in an upright position. Usually these types of signs, and their stakes, are used substantially in the real estate business, and are implanted usually upon the front lawn of the home under consideration for sale, and during usage, must be promptly installed, regardless of the ground in which it stakes, to achieve the signage intended function.

A concern for consumers of a wire type sign and its stakes, for supporting a corrugated or related sign, is that the sign stake must be both economical and durable. All wire sign stakes on the market are produced primarily the same way, with two pieces of wire steel rod as side pieces, spaced apart approximately the width of the sign, and the two pieces of the wire steel rod are either welded on top of the two side pieces, or between the two steel side pieces in its assembly. When installed, and pressure is exerted downwardly on the bottom piece of the welded wire, and many times, the bottom piece of the wire will bend, and/or break generally at the position of the weld. Thus, the welds may not withstand shear forces, which are needed to implant the sign into the ground, particularly where the ground may be of a rougher texture, or exhibit to much dryness.

On the improved wire stake of this invention the bottom piece is designed of a heavier gauge metal, of a square or rectangular configuration, and is bent into the shape needed to provide it with the ability to function as a durable stake, and therefore, virtually eliminates the bending/breakage of the stake, during usage. In addition, the ends of the bottom separated pieces are cut on a bevel, to function as a cutting edge, to allow for easier installation of the stake into the sub straight, particularly when the pressure of the agent's foot is applied upon the top horizontal integral portion of the formed stake.

There are some other patents that relate to this technology. For example, U.S. Pat. No. 4,894,937, shows a design that incorporates wire-like members, welded together for use for supporting corrugated or other signs. This design has both the top piece and the bottom piece welded to the two side pieces, however, with this type of design, when installed, the welds on the bottom piece can fail or break free from their connection, when pressure is applied during installation.

The patent to Kennedy, U.S. Pat. No. 5,042,183, shows a sign that has heavier wire-like members welded to light gauge wire like members, but only at the top of the shown sign. The lighter gauge wire-like members on the top are used so that the corrugated sign can be attached thereto. The sign post members, as shown, are attached to a cross bar, once again, by welding, as explained in the patent. In addition, there is no top piece welded across and onto the two side pieces, which substantially lessen the strength and stability of the shown sign. In addition, since welding is the means for attachment of the cross bar to the side post, once again, when pressure of the foot is applied to shown cross bar, there is always that potential that when excessive pressure is applied, as when the sign is to be installed into difficult ground, breakage may occur.

U.S. Pat. No. 7,437,844, shows a design that differs from the previous staked signs on the market. This design comprises five pieces of wire-like members. The heavier side pieces have two bends on each piece, having lighter gauge piece welded to the top of each side piece, and have a cross piece welded to the bottom of the side piece. While the heavier side pieces and cross piece may reduce breakage, there is no top piece welded across and onto the two side pieces, which results in instability, and during installation, may cause stresses that can provide for breakage of the sign during installation. This also allows for substantially less strength and stability.

The patent to Farmer, U.S. Pat. No. 4,660,310, shows another advertising copy display sign and stand combination.

The patent to Peck, U.S. Pat. No. 6,547,204, shows a further sign holding stake.

The patent to Pingel, U.S. Pat. No. 4,658,527, shows a further sign holder.

U.S. Pat. No. 4,660,310, shows a further advertising copy display sign and stand combination.

This substantially describes the type of prior art that is available in signage, relating to the technology of this invention.

### SUMMARY OF THE INVENTION

The current invention contemplates a wire sign stake for supporting a corrugated sign in an upright position. The improved wire stake has a unique design that incorporates two pieces of steel or other metal wire welded to a heavier piece of square or rectangular bent steel. The unique design has the heavier bent steel provided with significantly more strength, than the traditional wire stakes used for supporting a corrugated sign. In addition, because the heavier metal provided at the bottom of the sign is made of a square or rectangular stock, in configuration, it provides a flattened surface, step like of appearance, to which the shoe may be applied when forcing the sign support structure into the ground. This has a tendency to reduce the incident of slippage, which can cause injury to the foot.

The heavier bent steel forming the integral bottom portion of the stake incorporates a pair of side parts or piece, the lower ends of the side piece being beveled, so as to facilitate their embedment into the ground. The integral cross member at the upper ends of the side piece is formed from bending this bottom component from a single piece of metal stock. Thus, when the foot is applied to the cross member, it is far easier to embed the sign stake into the ground, with no breakage, since the forces are applied to an integral structure, that is not formed by welding or other connection. The structure is shaped as an inverted U shape part, of rectangular or square shape in cross section, so that pressure applied upon the cross member transmits force upon the side piece, forcing them into the ground, without any potential for breakage of the component, because it is formed from a singular piece of rod that is bent into the integrated U shaped configuration.

This structure is then welded to the bottom of a piece of metal like side rails, which may be of a lesser gauge steel than the lower structure, and the side rails are provided with an upper cross rail, to add stability to the sign stake, with the signage itself, such as a real estate sign, which nowadays are made of corrugated paperboard or plastic, and are simply applied to the upper edges of the side rails, through the insertion of the latter into the corrugations of the formed signed.

The essence of the structure of this device is to provide an integrated component in that lower section of the sign stake, that will not break when stepped on, and provide sufficient rigidity to the overall sign structure, during its usage and application. Through such significantly enhanced strength that is added to the sign through the usage of this stake means, even the application of any wind to the sign will not cause its breakage, or folding over, during its application and usage. Furthermore, because a heavier gauge of metal is utilized in the formation of the lower structure of this sign stake, when it is applied, such as through the application of foot pressure upon its cross member means, the downwardly depending integral side piece will not buckle, under the exerted pressure, during its application of the entire sign stake and its signage into the ground.

Another feature and modification to this invention includes a series of rods, all cut from the same bar stock used in the manufacture and assembly of a standard sign support, including a pair of side rails, a cross rod provided upwardly within the sign, integrally welded or connected to the side rails, and at that depth to limit the insertion of the sign upon the stake, during its application. In the lower part of the stake, there are a pair of additional short side rails, that are welded to the bottom ends of the main side rails, to add reinforcement to the stake at that location, and then a cross member is welded between the main side rails, and upon the short side rails, to function as the step upon which the user may apply pressure to drive the stake into the ground. Essentially, this feature of the invention provides for additional reinforcement at the bottom of the stake, through the use of a pair of side rails, rather than just a bottom part of the side rail formed of a rod of additional, double, or twice the diameter of the side rail itself. This allows the use of a singular rod material, for making the entire sign stake.

In addition, a further modification to the sign stake of this invention includes the fabrication of almost the entire stake from a singular rod of standard steel or metal material, where the bottom is bent to a configuration that integrally forms the stake part of the sign from this single rod. The only additional component is the welding or otherwise attachment of a cross rod higher up in the structure of the sign stake, that adds reinforcement at that location, and a limit to the insertion of the sign upon the stake, during its application. In addition, the structure of this modified design adds substantial reinforcement to the bottom of the stake, particularly in that region where pressure is applied to drive it into the ground. And to facilitate its application into the ground, the lower ends of the stake will be beveled, through grinding, or by other means, to provide somewhat pointed bottom edges to facilitate the application of the stake into the ground, when used.

It is therefore, an improved wire stake that has a unique design formed of two different pieces of steel or other metal, welded to a heavier piece of bent rectangular metal, forming the lower structure of the stake, to enhance the utility of this invention;

Another object of this invention is to provide a unique design for a sign stake that incorporates heavier bent steel and which provides significantly more strength than the traditional wire stakes used for supporting a corrugated sign.

Another object of this invention is to virtually eliminate breakage through usage of a design that incorporates, in those components upon which greater pressure is applied, of a heavier bent steel structure of rectangular shape configured into the sign stake of this invention.

Yet another object of this invention is to provide a sign stake, which when installed, and pressure is exerted downwards on the heavier bent steel component of the stake, its welds will not break and its impaling components will not buckle under such additional significant pressure.

Another object of this invention is to provide a lower structural component for a sign stake wherein its two bottom ends, those ends are impaled into the ground, are formed of the heavier bent metal stock that are cut at an angle or bevel so as to provide a “cutting edge” that digs into the substrate significantly easier than traditional stakes that have a blunt bottom end.

A further object of this invention is to provide a sign stake that can be inserted in to dry or frozen substrate, wherein traditional sign stakes will simply bend under the applied pressure.

Still another object of this invention is to provide a unique design for a sign stake wherein the heavier bent steel wire with ends cut at an angle will not bend in frozen or dry ground, when applied.

An additional object of this invention is to provide a unique and improved sign stake, which avoids the problem of traditional signs stakes, wherein pressure as applied downwardly with the foot when installed could cause their breakage, and frequently does.

Still another object of this invention is to provide a bottom structural part for a sign stake wherein the pressure exerted upon it will not effect any breakage, since welding is avoided in that part of the structured stake.

Still another object of this invention is to provide the cross member of the lower structure of a sign stake wherein it can be used for application of foot pressure, for forcing the stake into ground, in preparation for application of its signage.

Still another object of this invention is to provide a sign stake wherein its upper legs or side pieces comprised the wire-like members that extend into the open area of a formed corrugated sign, such as a real estate sign.

Still another object of this invention is to provide the two side pieces for the side wires that are welded to the lower or bottom structure have a series of indentations provided upon their length so as to allow for a more secure attachment of the corrugated sign upon their upper segments.

Another object of this invention is to provide an improved wire/flat stock metal stake that has a unique design that incorporates two pieces of steel wire welded to a piece of bent flat stock steel that is beveled at its lower edges.

A further object of this invention of this unique design is that with the bent flat stock having beveled edges, provides significantly more strength than the traditional wire stake used for supporting a corrugated sign.

A further object of this invention is to provide a sign support wherein breakage is virtually eliminated because of the design and usage of key stock and rectangular steel stock in the formation of its lower structure.

A further object of this invention is to provide the cross member for the lower structural component for the sign support that comprises and forms a step for being used to drive or insert the two side legs or side pieces of the sign support into the ground when supporting a sign on its upper end.

A further object is to provide a sign stake wherein its lower structure that is forced into the ground has a flattened surface, for a cross member, that allows the shoe of the applicator to step thereon, and reduce slippage, when driving the stake into the ground.

Another object of this invention is to provide a sign stake that can be used to facilitate the driving of the stake into the ground, when a corrugated sign, such as for use in real-estate, may then be applied to its upper region for display purposes.

Yet another object of this invention is to provide a sign stake that may hold, for example, a political sign, and facilitates the driving of the sign stake into the ground during its application and usage.

These and other object will become more apparent to those skilled in the art upon review of the summary of the invention as provided herein, and upon undertaken a study of the description of its preferred embodiment, in view of the drawings.

### BRIEF DESCRIPTION OF THE DRAWINGS

In referring to the drawings:

FIG. 1 is an exploded view of the sign stake of this invention, one wherein its bottom support structure is formed of square metal key stock, in cross section;

FIG. 2 provides a cross sectional view of the bottom support structure;

FIG. 3 shows the assembled sign stake of this invention;

FIG. 4 provides an exploded view of a modified sign stake of this invention;

FIG. 5 provides an erected view of the sign stake of FIG. 4;

FIG. 6 shows a sign stake of a further modified design, essentially constructed from a singular rod of material, and bent into the configuration of the finalized stake; and

FIG. 7 shows a sign stake of a further modified design, wherein the side rails extend to the lowest end of the assembled sign stake.

### DESCRIPTION OF THE PREFERRED EMBODIMENT

In referring to the drawings in particular FIG. 1, therein is shown an exploded view of the sign stake 1 of this invention, as structured, it includes a piece of side rails or wires 2 and 3, a cross rod 4, and a lower structure 5 that has utility to function as a reinforcement for the sign stake, as it is assembled and applied for usage. The lower structure 5 is also provided with a pair of side pieces 6 and 7, and an integral cross member 8 which are all bent at their corners 9 and 10, when the bottom structure is formed of a singular piece of square metal key stock. Preferably, this lower structure will be formed of a gauge of metal that is greater than the wire from which the wire side rails 2 and 3 are formed, and generally, it has been found that a thicker gauge key stock, of approximately 3/16″ gauge, having a thickness somewhere in the range of 3/16 of an inch to a quarter inch, will be used for the wire structure that is integrally bent into to the lower structure 5 as noted. The side wires, 6 and 7 as can be seen, are beveled or tapered at their lower ends, as at 11 and 12, and the purpose for this is when the user applies a foot to the cross member 8, in order to push the sign supporting structure into the ground, these beveled ends 11 and 12 will cut into the turf, and more easily provide for their impalement into the ground, when setting the sign stake up for usage.

Since there is a heavier gauge metal stock provided within the lower structure 5, the upper structure, which does not have that much force applied to it, can be made of a lesser gauge of wire, and therefore, provide for cost reduction in the manufacture and assembly of the sign stake 1, when being prepared for usage. For example, the upper wires that form the member 2, 3 and 4, may be made of a 9 gauge wire, which may be somewhere in the vicinity of ⅛ inch, more or less, in diameter, since the only weigh that will be applied to this part of the sign stake is the application of the light weigh corrugated sign itself, when installed. The only force applied to this part of the sign will be the weight of the sign, which is miniscule, or when wind forces are applied against it, so that the side rails formed of a number 9 gauge wire have been found to be sufficient to resist bending under higher wind forces, when they are encountered.

As can be seen in FIG. 1, as noted at 13, the heavier gauge metal that is used for forming the lower support member or structure 5 is made of key stock, as to be noted, is square in configuration, and therefore on its upper surface, where it forms the cross member 8, has a flattened configuration, as at 14, so that, as for example, when a real estate agent steps onto that part of the structure, the surface 14 acts as a step, and prevents the shoe from slipping, while the sign stake is being forced into the ground. For example, when the agent may have high heels on, this type of structural support, therefore, adds to the safety of usage of this device.

The cross rail 4, when installed, will be located and welded intermediate the side rails 2 and 3, approximately a foot or more below the top ends of the said side rails, so as to add structural support to the sign at that location, and also function as a stop for the corrugated real estate sign, or other sign, as it is applied to the upper ends of the side rails, and slid downwardly for its application in place, when used.

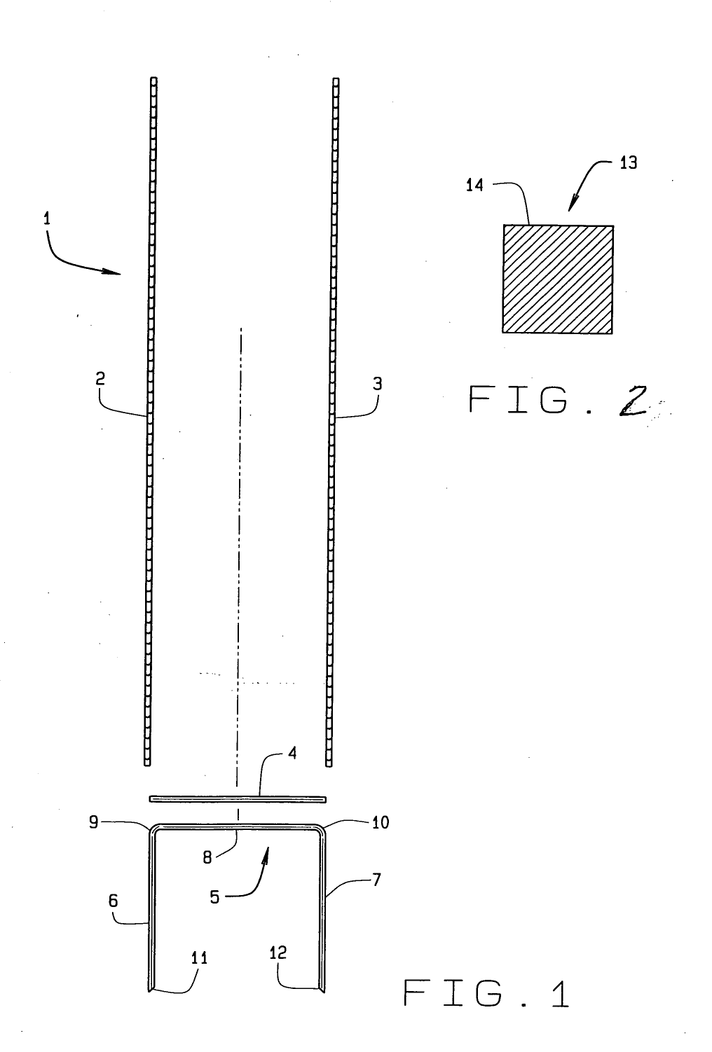

FIG. 2 shows a cross section of the cross rod 4, and how it is constructed of rectangular metal stock for reinforcement purposes.

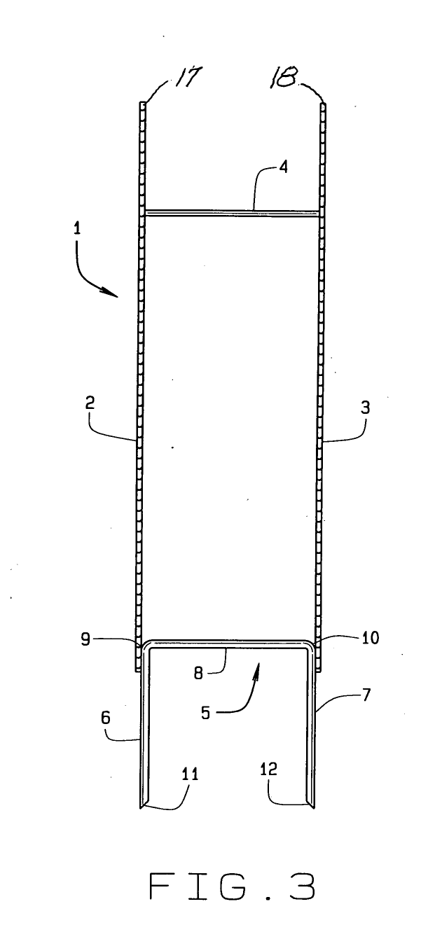

In referring to FIG. 3, the structure of the sign stake shown herein is almost identical to that as described for the stake of FIG. 1. The primary difference is that the lower support 5 is fabricated from metal flat stock, as can be seen at 14, and which has a more of a rectangular configuration, in cross section, forming a greater surface area upon which the foot may locate, when driving the sign stake into the ground.

As can be seen in FIG. 3, which shows the completed and assembled sign stake 1, it can be seen that the side rails 2 and 3 have the cross rail or rod 4 welded intermediate the two side rails, to add the structural rigidity of the stake, as it is applied, and to furnish a lower stop against which the bottom end of the corrugated sign, when applied thereto, will encounter when fully inserted during usage, as explained. In addition, it can be seen that the lower structure 5 as formed of a heavier metal stock, and it has the side rails 2 and 3 secured by welding, as at 9 and 10, to the lower structure 5, upon the upper surface, when fully assembled. Thus, when pressure is applied upon the cross member 8, as when a foot is applied thereon, because of the integration of the lower structure formed from a singular piece of heavier square or rectangular metal, all forces are applied upon the member 5, which impales the lower ends 11 and 12 into the ground, when installed.

In usage, the corrugated sign, whose medium incorporates a series of open internal voids, is applied in alignment to the upper ends of the shown side rails. It extends down to the location of the cross rod 4, which prevents further application of the corrugated sign thereto, when installed. These wire-like members 2 and 3, at their ends 17 and 18, will slide into the openings of the corrugated sign, and particularly its medium, provided between the two outer liners of the formed corrugated sign. In operation, when one intends to install the wire sign and its stake into its substrate, he/she will put pressure on the bottom heavier bent piece of metal forming the bottom structure, as upon its cross member 8 through application of ones foot. As stated, the mitered/angled bottom parts 11 and 12 of the lower side pieces allow for easy installation into the substrate, or ground. When enough pressure is applied on the bottom heavier bent piece, or lower structure, with one's foot, the wire stake is embedded into the substrate so that it will stand erect, and remain so, throughout its installation and usage.

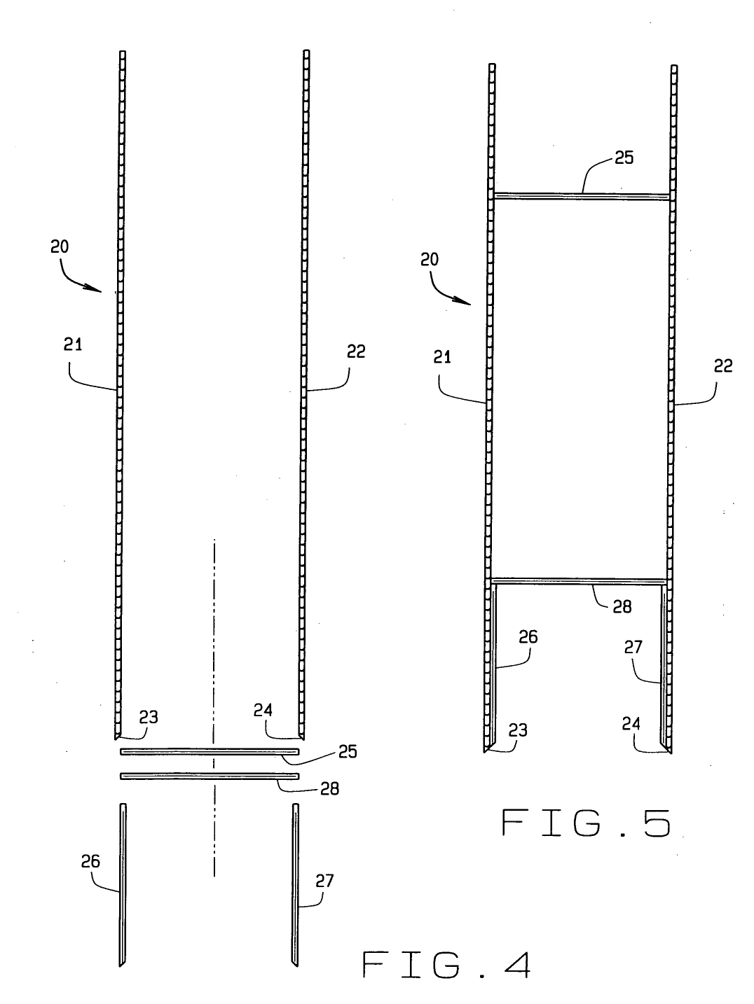

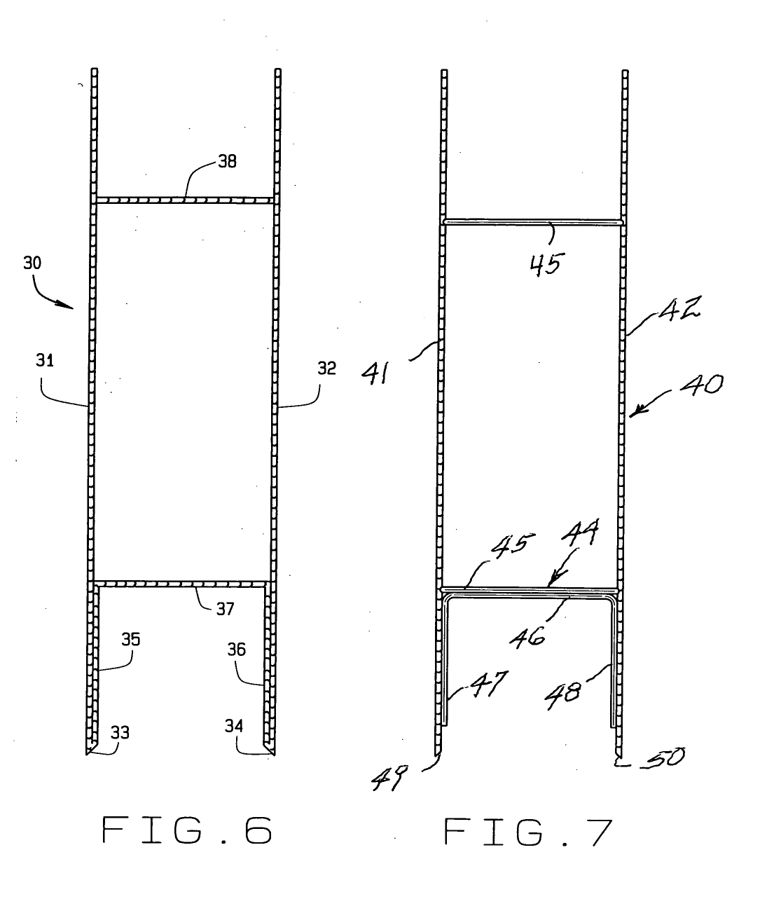

In referring to FIG. 4, this provides an exploded view of the modification to the sign stake of this invention. The sign stake is generally identified at 20, and includes a pair of side rails 21 and 22 that extend the full length of the stake, having their bottoms ends beveled, as at 23 and 24, either by grinding, or by other means, in order to provide a somewhat pointed lower end to facilitate the driving of the finished stake into the ground. A cross rod 25 is provided for installation in the upper part of the stake, as previously reviewed. This provides stability at the upper end of the stake, and likewise limits the sliding engagement of a corrugated signage onto the stake, when used. At the bottom of the stake are a pair of supplemental side rails 26 and 27, that are welded in place against generally the inner surface of the lower ends of the side rails 21 and 22, to add reinforcement to the structure of the device. Then, a cross member 28 is welded to the upper ends of the short side rails 26 and 27, to provide reinforcement at that location for the stake, and in addition, furnishes a cross member upon which pressure may be applied, as by the foot, when driving the stake into the ground. The fully assembled sign stake 20 can be seen in its assembled condition in FIG. 5. The material used in the manufacture of the sign stake of FIG. 4, in addition to that which may be used in the stake of FIG. 6, is that No. 9 gauge wire, which may have a diameter somewhere in the vicinity of ⅛^{th} inch, more or less, and which will have a series of ribs provided around its periphery, every inch or so, in order to provide a means for attachment of the corrugated sign to the stake, once it is erected. This type of wire will be a mill finish grayed steel, generally galvanized steel, which will therefore allow for a longer life of usage for the sign stake, even under harsh environment conditions.

In referring to FIG. 6, a further modification to the structure of the sign stake is disclosed. In this particular embodiment, the sign stake 30 is shown in its fully assembled state. The advantages of the stake made by this method includes the fabrication of the side rails 31 and 32 which at their lower ends are integrally bent inwardly, as at 33 and 34, and extend upwardly to provide short sections of side rails 35 and 36, to add reinforcement to the bottom structure of the stake, and then includes an integral cross member 37 that provides the location upon which a foot pressure may be applied, in order to facilitate the driving of the stake into the ground. Essentially, all of these components 31-37 are formed from a singular rod of material, as can be noted. In addition, the lower ends of the stake, where they bend upwardly, as at 33 and 34, may be slightly beveled, as through grinding, or by other means, in order to add a somewhat pointed lower edge to facilitate the driving of the stake into the ground, during its application. The only other individual and separate piece of material that is provided within the stake is the cross rail 38 that may be welded or otherwise secured between the upper portions of the side rails 31 and 32, as can be noted. Essentially, in this condition, this entire sign can also be fabricated of that No. 9 gauge wire, which is approximately ⅛^{th} inch more or less in diameter, and does not require the usage of any heavier stock, even at the lower regions of the constructed sign, as can be understood.

Yet a further modification to the subject matter of this invention is shown in FIG. 7. In this embodiment, the sign stake 40 includes the pair of side rail 41 and 42, having a cross rail 43 provided in its upward section. The bottom structure 44 includes a cross member 45 that adds reinforcement thereto, and further includes the support structure 46 that includes a horizontal portion, and the integral downward portions 47 and 48 that add further reinforcement at this location. It is to be noted that the side rails 41 and 42 extend downwardly form the parts 47 and 48, and include the sharpened lower ends, as at 49 and 50, to assure that the sign stake can be facilely embedded into the ground or soil, when it is erected for usage.

Variations or modifications to the structure of the invention as defined herein may occur to those skilled in the art upon review of the invention as disclosed herein. Such variations, if within the spirit of this invention, are intended to be encompassed within the scope of any claims to patent protection issuing hereon. The description of the invention in the preferred embodiment, and its depiction in the drawings, is done for illustrative purposes only.

I claim:

1. A wire sign stake, comprising:
a pair of side rails, a cross rail applied laterally intermediate the side rails at an approximate upper location within the formed sign stake, said cross rail being welded to the two side rails in its installation;
a bottom structure, said bottom structure formed of a singular heavier gauge of square or rectangular metal stock into an integral structure formed having two side pieces, extending downwardly, and an integral cross member extending between the upper ends of the side pieces, said cross member forming a flat upper surface functioning as a step to facilitate stepping thereon for driving the stake into the ground;
the side rails of the sign stake being welding proximate the bent corners of the said lower structure;
whereby a corrugated sign may be attached by sliding onto the upper ends of the side rails, and extending it down to the cross rail, for installation, and whereby pressure from one's foot applied upon the cross member functions to drive the sign stake into the ground, while preventing any bending, buckling, or breakage of the sign stake during its installation.

2. A wire sign stake, comprising:
a pair of side rails, a cross rail applied laterally intermediate the side rails at an approximate upper location within the formed sign stake, said cross rail being welded to the two side rails in its instillation;
a bottom structure, said bottom structure integrally formed from the same metal rod used in the fabrication of the side rails, said bottom structure including upwardly bent short lower side rails that extend a short distance upwardly along the lower portion of the side rails, and further includes an inward and integrally formed cross member at the upper ends of the lower short side rails, to provide a sign stake fully constructed of a singular rod of material, to facilitate its driving into the ground during usage;
whereby a corrugated sign may be attached by sliding onto the upper ends of the side rails, and extending it down to the cross rail, for installation, and whereby pressure from one's foot applied upon the cross member functions to drive the sign stake into the ground, while preventing any bending, buckling or breakage of the sign stake during its instillation.

3. A wire sign stake, comprising:
a pair of side rails, a cross rail applied laterally intermediate the side rails at an approximate upper location within the formed sign stake, said cross rail being welded to the two side rails in its installation;
a bottom structure, said bottom structure formed of a pair of short side rails, secured to the corresponding lower portion of the sign side rails, and a cross member secured to the upper edges of the lower short side rails, to function as a step to facilitate stepping thereon for driving the stake into the ground;
the lower ends of the side rails and the short section side rails being beveled to facilitate the driving of the sign stake into the ground;
whereby a corrugated sign may be attached by sliding unto the upper ends of the side rails, and extending it down to the cross rail, for installation, and whereby pressure from one's foot applied upon the cross member functions to drive the sign stake into the ground, while preventing any bending, buckling, or breakage of the sign stake during its instillation.

4. The wire sign stake of claim 3, and including a reinforcing cross member provided upon the bottom structure cross member, to add reinforcement to the wire sign stake during usage.

5. The wire sign stake of claim 4, wherein said reinforcing cross member is formed of multisided metal.

6. The wire sign stake of claim 5 wherein said reinforcing cross member is of rectangular cross section.

7. The wire sign stake of claim 5 wherein said reinforcing cross member is of square cross section.
